(19) United States
(12) Patent Application Publication
(10) Pub. No.: US 2007/0136804 A1
(43) Pub. Date: Jun. 14, 2007

(54) METHOD AND APPARATUS FOR LOGIN LOCAL MACHINE

(76) Inventors: Takayuki Ohsawa, Tokyo (JP); Masakazu Itou, Tokyo (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/559,964

(22) Filed: Nov. 15, 2006

(30) Foreign Application Priority Data
Nov. 18, 2005 (JP) 2005-334491

(51) Int. Cl. G06F 15/16

(52) U.S. Cl. 726/14

(57) ABSTRACT

An information processing system 10 comprising a plurality of information processing apparatuses 300, a management server 100, and a plurality of terminals 200, wherein: the management server 100 includes a connection management table 125, and an address notification unit 110 for receiving an apparatus use assignment request from the terminal 200, identifying an address of the corresponding information processing apparatus 300 by checking stored information of an authentication media 50 against the connection management table 125, and notifying the identified address to the terminal 200; the terminal 200 includes an authentication information obtaining unit 210 for obtaining the stored information of the authentication media 50 through a reader 60 for the authentication media 50, and storing the obtained information in an appropriate RAM 203, a management server address storage unit 211 for storing an address of the management server 100, an apparatus use assignment request sending unit 212 for sending a request for an assignment of the information processing apparatus 300 to the address of the management server 100, an address obtaining unit 213 for receiving the address of the information processing apparatus 300 from the management server 100, and storing the received address in the RAM 203, and a remote control unit 214 for sending manipulation information to the address of the information processing apparatus 300, receiving image information from the information processing apparatus 300, and displaying the received image information; the information processing apparatus 300 includes a remote control receiving unit 310 for receiving the manipulation information from the terminal 200, performing information processing according to the manipulation, and sending to the terminal 200 the image information showing the processing result.

### INCORPORATION BY REFERENCE

This application relates to and claims priority from Japanese Patent Application No. 2005-334491 filed on Nov. 18, 2005, the entire disclosure of which is incorporated herein by reference.

### BACKGROUND OF THE INVENTION

1. Field of the Invention

The present invention relates to an information processing system, a management server, a terminal, and an information processing apparatus.

2. Related Art

For example, with the aim of realizing single login process utilizing a mobile media in a corporation information system, Japanese Patent No. 3659019 discloses a method for controlling single login utilizing a mobile media in a system where a client, a business server, and an integrated authentication server are connected with each other, wherein the client accepts a login process that a user performs using authentication information and the mobile media, and the client verifies the user based on the login process performed using the authentication information and the mobile media, and then, according to the result of the verification, the client obtains login information stored in the mobile media that is used for logging in to the business server and the integrated authentication server, and the client performs the process of logging in to the business server and the integrated authentication server using the obtained login information.

Furthermore, Japanese Patent Application Laid-open Publication No. 2003-263418 discloses a security system difficult to be intruded and attacked from outside so as to ensure high security. In this security system, a terminal on which a security card is loaded, a security server, and at least one information system are connected to a network. The security card is provided with a means for sending security information, a means for storing a connection menu and a connection address regarding the information system which the security server sends in response to receiving the security information, and a means for displaying the connection menu from which a user selects the desired information system. The security server stores, along with the connection menu and the connection address, security information used for determination by the server that is issued for each of the terminals, and refers to this information based on the security information sent from the terminal, and is provided with a means for sending to the terminal permission information including the connection menu and the connection address in the case that the terminal is authenticated as an authorized user.

### SUMMARY OF THE INVENTION

Now, in a corporation or other organizations, cost and labor required for personal computers management including install/upgrade of software and maintenance of hardware have been becoming a nonnegligible problem. Then, there is appearing a new concept of thin client, that is, the concept of using as a client computer a specialized computer (thin client) which is omitted a hard disk device and the like and is equipped with minimum capabilities such as display and input, and having resources such as application software centrally managed in a server.

Here, when a thin client requests an access to its own server such as a blade server, reliable access control should be performed on the server side in order to determine which server the thin client may access to. In addition, in view of a possible situation where a thin client might be illegally used by a malicious unauthorized user, it is required to prepare an authentication procedure ensuring high security, such that an access to a server is not permitted until appropriate processes are completed.

Meanwhile, as an authentication media used in such an authentication procedure, for example, there may be adopted a transportation IC card (prepaid fare card and/or electronic commuter pass, etc.) equipped with a wireless IC chip. This kind of transportation IC card has certain advantages such that it is already in widespread use and can offer excellent portability due to its thinness and lightness. However, a wireless IC chip mounted on it generally does not have large storage capacity, and is non-recordable or is not allowed to be recorded for the purpose of securely managing stored information even if recordable technically, thereby making it difficult to conveniently utilize a transportation IC card as a storage of information required in an authentication procedure.

The present invention has been contrived in consideration of the above-mentioned problem, and an object thereof is to provide an information processing system, a management server, a terminal, and an information processing apparatus that make it possible to ensure appropriate security and usability in a thin client system with use of an authentication media having excellent portability.

In order to achieve the foregoing and other objects, one aspect of the present invention is an information processing system comprising a plurality of information processing apparatuses, a management server for managing the information processing apparatuses, and a plurality of terminals, which are connected with each other through a network, wherein:

the management server includes
a connection management table for storing a relationship between stored information of an authentication media used by a user of each of the plurality of terminals and an address of the information processing apparatus that is assigned to be used by the terminal associated to the authentication media, and
an address notification unit for receiving from the terminal an apparatus use assignment request including the stored information of the authentication media, checking the stored information of the authentication media that is included in the received request against the connection management table, identifying the address of the corresponding information processing apparatus, and notifying the identified address to the terminal that is the sender of the apparatus use assignment request;

the terminal includes
an authentication information obtaining unit for obtaining the stored information of the authentication media through a reader for the authentication media, and storing the obtained information in an appropriate memory,
a management server address storage unit for storing an address of the management server,
an apparatus use assignment request sending unit for retrieving the stored information of the authentication media from the memory, putting the retrieved stored information in the apparatus use assignment request, and sending this apparatus use assignment request to the management server address stored in the management server address storage unit,
an address obtaining unit for receiving from the management server the address of the information processing apparatus assigned to the terminal, and storing the received address in an appropriate memory, and
a remote control unit for sending manipulation information inputted through an input interface of the terminal to the information processing apparatus address stored in the memory, and receiving from the information processing apparatus image information corresponding to the sent manipulation information, and displaying the received image information on an output interface of the terminal; and

the information processing apparatus includes a remote control receiving unit for receiving the manipulation information from the terminal, performing information processing according to manipulation indicated by the received manipulation information, and sending the image information showing the processing result to the terminal.

According to the present invention, it is possible to ensure appropriate security and usability in a thin client system with use of an authentication media having excellent portability.

### BRIEF DESCRIPTION OF THE DRAWINGS

FIG. 1 is a diagram showing an exemplary network structure of a remote desktop system embodying an information processing system according to the present invention;

FIG. 2 is a diagram showing an exemplary structure of a management server according to the present invention;

FIG. 3 is a diagram showing an exemplary structure of a remote machine embodying a terminal according to the present invention;

FIG. 4 is a diagram showing an exemplary structure of a local machine embodying an information processing apparatus according to the present invention;

FIG. 5 is a diagram showing an exemplary structure of an IC chip mounted in an authentication media according to the present invention;

FIGS. 6A and 6B are diagrams respectively showing exemplary data structures of a connection management table and a remote machine management table according to the present invention;

FIG. 7 is a diagram showing an example of a first process flow in an information processing method according to the present invention;

FIG. 8 is a diagram showing an example of a second process flow in the information processing method according to the present invention.

### DESCRIPTION OF AN EMBODIMENT

While the present invention is susceptible of embodiments in many different forms, there is shown in the drawings and will herein be described in detail, one exemplary embodiment of the invention with the understanding that the present disclosure should be considered as an exemplification of the principles of the invention and not be construed limitative to the invention.

System Structure

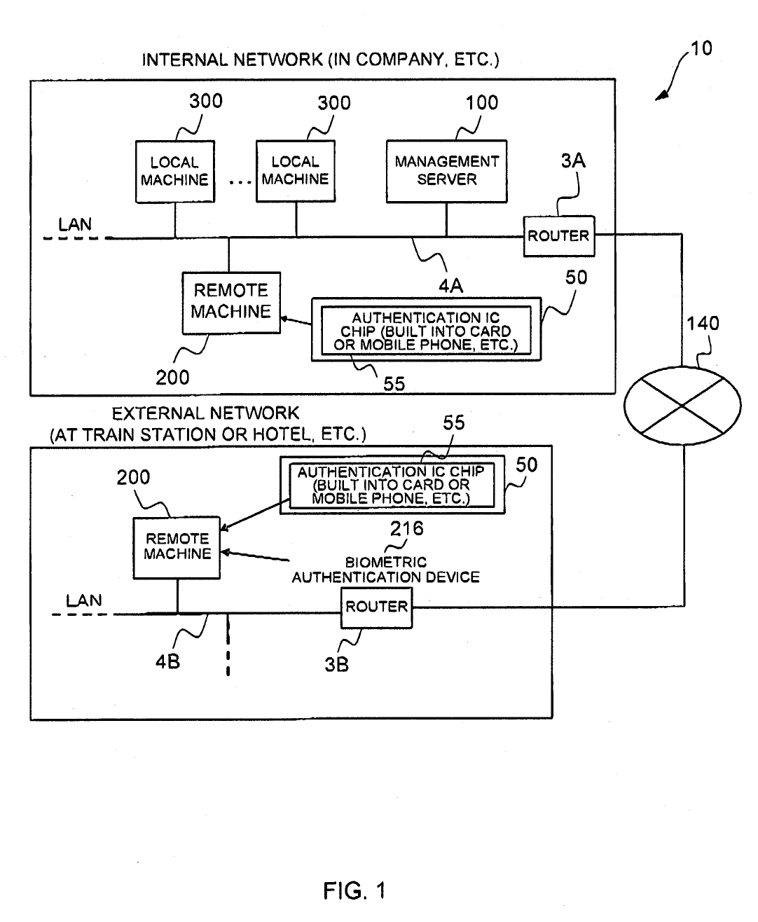

FIG. 1 is a diagram showing an exemplary network structure of a remote desktop system 10 in the present embodiment. The remote desktop system 10 is an example of a system embodying an information processing system in the present invention, though the information processing system may be embodied as any suitable system in any suitable form. As shown in FIG. 1, the remote desktop system 10 comprises a plurality of local machines 300 working as blade servers, a management server 100 for managing the local machines 300, and a plurality of remote machines 200 working as thin clients, which are connected with each other through a network 140. The local machine 300, the management server 100 and the remote machine 200 are respectively examples of apparatuses embodying an information processing apparatus, a management server and a terminal in the present invention which may be embodied as any suitable apparatuses or the like in any suitable forms. Data communication between the remote machine 200 as a thin client and the local machine 300 as a blade server is under the management of the management server 100.

The management server 100, the remote machines 200, and the local machines 300 are connected to a LAN (Local Area Network) 4A which is an intranet built in a company or the like. The LAN 4A is connected via a router 3A to the network 140, which may be a WAN (Wide Area Network) or the like. Not only within the intranet (i.e. inside the company), the remote machine 200 may be also used under the circumstance of being connected to an external network in somewhere outside the company, such as a hotel or a train station. In this case, the remote machine 200 is first connected to a LAN 4B which is an external network, and then connected via a router 3B to the network 140, which may be a WAN or the like.

It should be noted that the local machine 300 establishes a VPN (Virtual Private Network) with the remote machine 200, and through this VPN, receives input information (user manipulation of an input device) to process it, and sends image information showing the process result (a desktop screen of a display device) to the remote machine 200. The local machine 300 is a computer that is generally used without input and output devices locally connected therewith, such as a blade server.

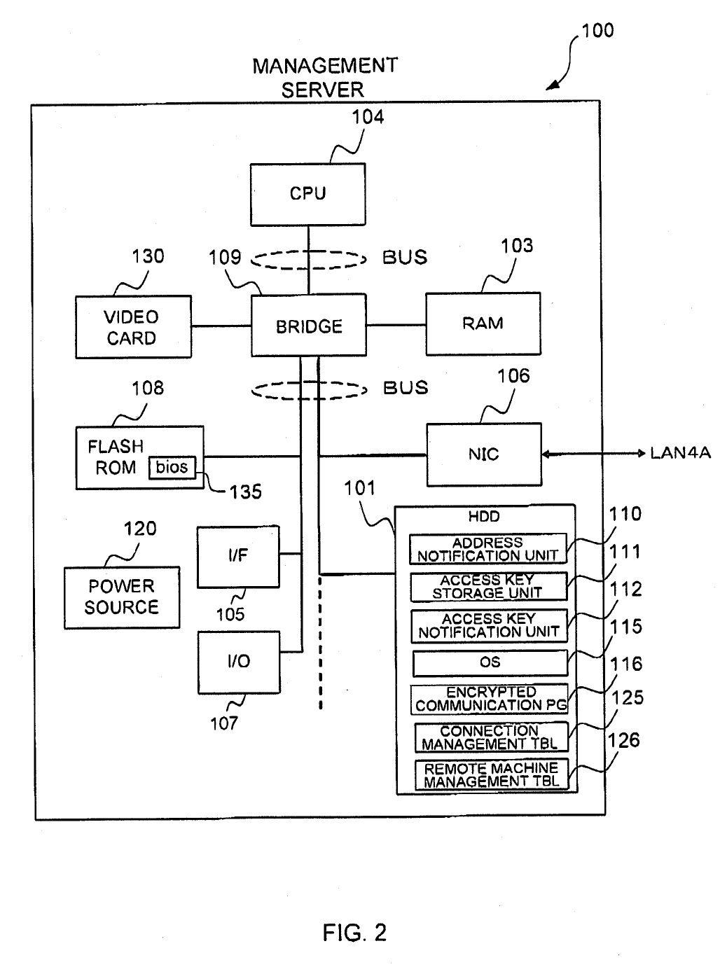

In the following, a description is given as to each of the apparatuses included in the remote desktop system 10 in the present embodiment. FIG. 2 is a diagram showing an exemplary structure of the management server 100 in the present embodiment. In order to implement functions for realizing the present embodiment, the management server 100 reads out to a RAM 103 a program 102 contained in a program database stored in a hard disk drive 101 or the like, and executes the program 102 by a processing unit, a CPU 104.

Further, the management server 100 includes an input/output interface 105, which may be in the form of, for example, a keyboard, a button, a display or other input/output means, as commonly equipped with a computer device. The management server 100 also includes a NIC (Network Interface Card) 106 for exchanging data with the remote machine 200, the local machine 300 and others.

The management server 100 connects and exchanges data with the remote machine 200, the local machine 300 and others by the NIC 106 through the network 140, which may be in the form of, for example, the Internet, a LAN, or a serial interface communication line. An I/O unit 107 is responsible for data buffering and various intermediary processing between the NIC 106 and the functional components of the management server 100. The management server 100 further includes a flash ROM 108, a video card 130 to which a display device is connected, a bridge 109 which bridges between buses connecting the above-mentioned components 101 to 130, and a power source 120.

A BIOS 135 is stored in the flash ROM 108. When the power source 120 is turned on, the CPU 104 first accesses the flash ROM 108 and executes the BIOS 135, and thereby recognizes the system configuration of the management server 100. In addition, an OS 115, along with various functional units, tables and others, is stored in the hard disk drive 101. The OS 115 is a program enabling the CPU 104 to perform overall control of the components 101 to 130 of the management server 100 and implement the functional units described herein below in detail. The CPU 104 loads the OS 115 from the hard disk drive 101 to the RAM 103 by running the BIOS 135, and thereby performs overall control of the components of the management server 100.

Next, a description is given as to each of the functional units that the management server 100 sets up and retains, for example, based on the program 102. It should be noted here that the management server 100 stores, in an appropriate storage device such as a hard disk, a connection management table 125 for storing a relationship between stored information of an authentication media 50 used by a user of each of the plurality of remote machines and an address of the local machine 300 that is assigned to be used by the remote machine 200 associated with the authentication media 50.

The management server 100 includes an address notification unit 110 for receiving from the remote machine 200 an apparatus use assignment request including the stored information of the authentication media 50, checking the stored information of the authentication media 50 that is included in the received request against the connection management table 125, identifying the address of the corresponding local machine 300, and notifying the identified address to the remote machine 200 that is the sender of the apparatus use assignment request.

Preferably, the management server 100 further includes a remote machine management table 126 for storing authentication information of each of the plurality of remote machines, an access key storage unit 111 for storing an access key to a storage area of the authentication media 50. In this case, preferably, the management server 100 further includes an access key notification unit 112 for receiving from the remote machine 200 an access request including the authentication information of the remote machine 200, determining whether or not to accept an access requested from the remote machine 200 by checking the authentication information included in the received access request against the remote machine management table 126, and if the requested access is determined acceptable, then retrieving the access key from the access key storage unit 111, and notifying the retrieved access key to the remote machine 200 that is the sender of the access request.

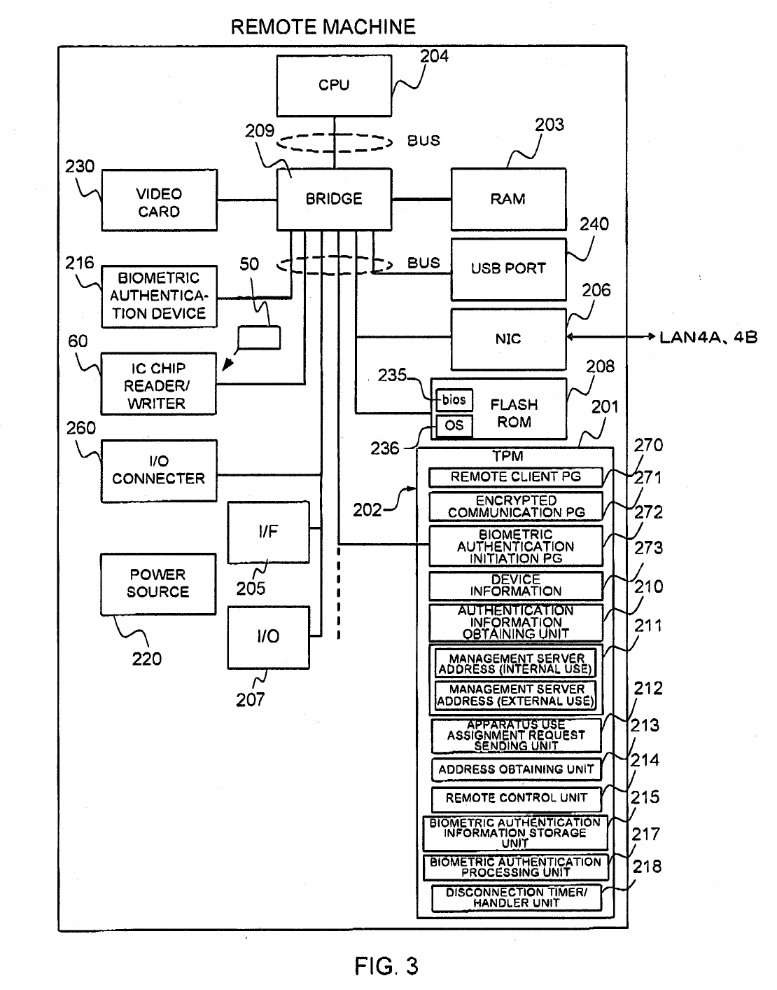

FIG. 3 is a diagram showing an exemplary structure of the remote machine 200 in the present embodiment. The remote machine 200 is an apparatus that uses through a network the local machine 300 assigned by the management server 100. In order to implement functions for realizing the present embodiment, the remote machine 200 reads out to a RAM 203 a program 202 contained in a program database stored in a TPM 201 or the like, and executes the program 20 by a processing unit, a CPU 204.

Further, the remote machine 200 includes an input/output interface 205 which may be in the form of, for example, a keyboard, a button, a display, or other input/output means, as commonly equipped with a computer device. The remote machine 200 also includes a NIC (Network Interface Card) 206 for exchanging data with the management server 100, the local machine 300 and others.

The remote machine 200 connects and exchanges data with the management server 100, the local machine 300 and others by the NIC 206 through the network 140 which may be in the form of, for example, the Internet, a LAN, or a serial interface communication line. An I/O unit 207 is responsible for data buffering and various intermediary processing between the NIC 206 and the functional components of the remote machine 200.

The remote machine 200 is a so called HDD-less PC, and is configured so as to be impossible to have a printer, an external drive, an external memory, and the like connected thereto locally or through a network. That is, the remote machine 200 is configured such that it can use only a printer, an external drive, an external memory, and the like connected to the local machine 300 locally or through a network. With such configuration, it becomes possible to reduce the risk of information leak that otherwise might be caused by a theft of the remote machine 200.

The remote machine 200 further includes a USB port 240 to which other devices are connected, a flash ROM 208, an I/O connector 260 to which a keyboard or a mouse is connected, a video card 230 to which a display device is connected, a bridge 209 which bridges between buses connecting the above-mentioned components 201 to 260, and a power source 220. When the power source 220 is turned on, the CPU 204 first accesses the flash ROM 208 and executes a BIOS 235, and thereby recognizes the system configuration of the remote machine 200.

An OS 236 stored in the flash ROM 208 is a program enabling the CPU 204 to perform overall control of the components 201 to 260 of the remote machine 200 and execute programs corresponding to functional units described herein below. The CPU 204 loads the OS 236 from the flash ROM 208 to the RAM 203 by running the BIOS 235, and starts the OS 236. It should be noted that, in the present embodiment, a relatively small-sized OS storable in the flash ROM 208, such as a built-in OS, is used as the OS 236.

Next, a description is given as to each of the functional units that the remote machine 200 sets up and retains in the TPM 201, for example, based on the program 202. The remote machine 200 includes an authentication information obtaining unit 210 for obtaining the stored information of the authentication media 50 through a reader 60 for the authentication media 50 used by a user of each of the remote machines, and storing the obtained stored information in an appropriate RAM such as the RAM 203.

Further, the remote machine 200 includes a management server address storage unit 211 for storing an address of the management server 100. The management server address storage unit 211 stores, for example, an internal address that is required in connecting to the management server via an internal LAN, and an external address that is required in connecting to the management server via an external network.

Further, the remote machine 200 includes an apparatus use assignment request sending unit 212 for retrieving the stored information of the authentication media 50 from the RAM 203, and putting the retrieved stored information in an apparatus use assignment request which is to request an assignment of the local machine to use, sending this apparatus use assignment request to the address of the management server 100 stored in the management server address storage unit 211.

Further, the remote machine 200 includes an address obtaining unit 213 for receiving from the management server 100 the address of the local machine 300 assigned to the remote machine 200, and storing the obtained address in an appropriate RAM such as the RAM 203.

Further, the remote machine 200 includes a remote control unit 214 for sending manipulation information inputted through the input interface of the remote machine 200 to the address of the local machine 300 stored in the RAM 203, and receiving image information corresponding to the sent manipulation information from the local machine 300, and displaying the received image information on the output interface of the remote machine 200.

Further, the authentication information obtaining unit 210 of the remote machine 200 may receive the access key from the management server 100, access the storage area of the authentication media 50 through the reader 60 for the authentication media 50 using the received access key, obtain the stored information in the storage area, and store the obtained information in an appropriate RAM, such as the RAM 203.

Further, the remote machine 200 may include a biometric authentication information storage unit 215 for storing biometric authentication information of a remote machine user, and a biometric authentication device 216 for obtaining biometric information of a remote machine user. In this case, preferably, the remote machine 200 includes a biometric authentication processing unit 217 for performing a biometric authentication process by checking the biometric information obtained through the biometric authentication device 216 against the information in the biometric authentication information storage unit 215, and terminating the apparatus use assignment process for assigning the local machine 300 to the remote machine 200 if the user is not authenticated in the biometric authentication.

Preferably, the remote machine 200 further includes a disconnection timer/handler unit 218 which detects, through the reader 60 for the authentication media 50, an event that data communication between the authentication media 50 and the reader 60 is ceased over a predetermined time period, and according to the detected event, performs a process of terminating the access from the remote machine 200 to the local machine 300.

In the remote machine 200 in the present embodiment, a chip called TPM (Trusted Platform Module) 201 stores the authentication information obtaining unit 210, the management server address storage unit 211, the apparatus use assignment request sending unit 212, the address obtaining unit 213, the remote control unit 214, the biometric authentication information storage unit 215, the biometric authentication processing unit 217, the disconnection timer/handler unit 218, a remote client program 270, an encrypted communication program 271, a biometric authentication initiation program 272, device information 273, and so on.

The TPM 201 has functionality similar to that of a security chip mounted on a smart card (IC card), and is a hardware chip having the function of asymmetric-key operation and the feature of tamper resistance for securely storing such keys. The TPM 201 provides the functions of, for example, generating and storing RSA (Rivest-Shamir-Adleman Scheme) private-key, RSA private-key operation (signature, encryption, decryption), SHA-1 (Secure Hash Algorithm 1) hash operation, storing platform status information (software measurements) (PCR), anchoring chain of trust for keys, digital certificates, and other credentials, high quality random number generator, non-volatile storage, Opt-in, I/O and so on.

The TPM 201 provides the function of securely storing platform status information (software measurements) in PCR (Platform Configuration Registers) in the TPM 201 and reporting this information, in addition to the function of encryption key (asymmetric-key) generation/storage/operation. If the TPM 201 is in accordance with the latest specification, it further includes the features of locality, delegation (delegation of authority), and the like. The TPM 201 is physically disposed on a component of a platform or the like (for example, motherboard).

Further, the remote machine 200 in the present embodiment stores the remote client program 270 and the encrypted communication program 271 in the above-mentioned TPM 201. The remote client program 270 is a program enabling the remote machine 200 to remotely access the desktop of the local machine 300, and may be embodied as, for example, a VNC client (viewer) program. The CPU 204, under the support of the OS 236, loads the remote client program 270 from the TPM 201 to the RAM 203 and executes it. This enables the CPU 204 to send input information inputted through the I/O connector 260 (user manipulation of a keyboard or a mouse) to the local machine 300 through the network 140 which may be a VPN, and then output image information sent from the local machine 300 (a desktop screen of a display) through the network 140 which may be a VPN to the input/output interface 205 such as a display connected to the video card 230, or other output means.

The encrypted communication program 271 is a communication program for establishing a secured communication network such as a VPN between the remote machine 200 and the local machine 300 whose address is notified from the remote client program 270, and may be embodied as, for example, an Ipsec-based communication program. The CPU 204, under the support of the OS 236, loads the encrypted communication program 271 from the TPM 201 to the RAM 203 and executes it. This enables the CPU 204 to send a communication start request to the local machine 300 assigned to the remote machine 200 through the NIC 206, and establish a network such as a VPN with the local machine 300, and communicate with the local machine 300 through this network.

Further, the remote machine 200 in the present embodiment stores the biometric authentication initiation program 272 in the TPM 201. The biometric authentication initiation program 272 recognizes the hardware configuration of the remote machine 200 upon start up of the remote machine 200, and instructs the biometric authentication processing unit 217 to start a biometric authentication process if the biometric authentication device 216 is included in the hardware configuration.

Further, the remote machine 200 in the present embodiment stores the device information 273 in the TPM 201. The device information 273 is authentication information of the remote machine 200 to be included in an access request when the remote machine 200 sends the access request to the access key notification unit 112. Particularly, the device information 273 may be in the form of, for example, an ID, a model number, or a MAC address of the remote machine 200.

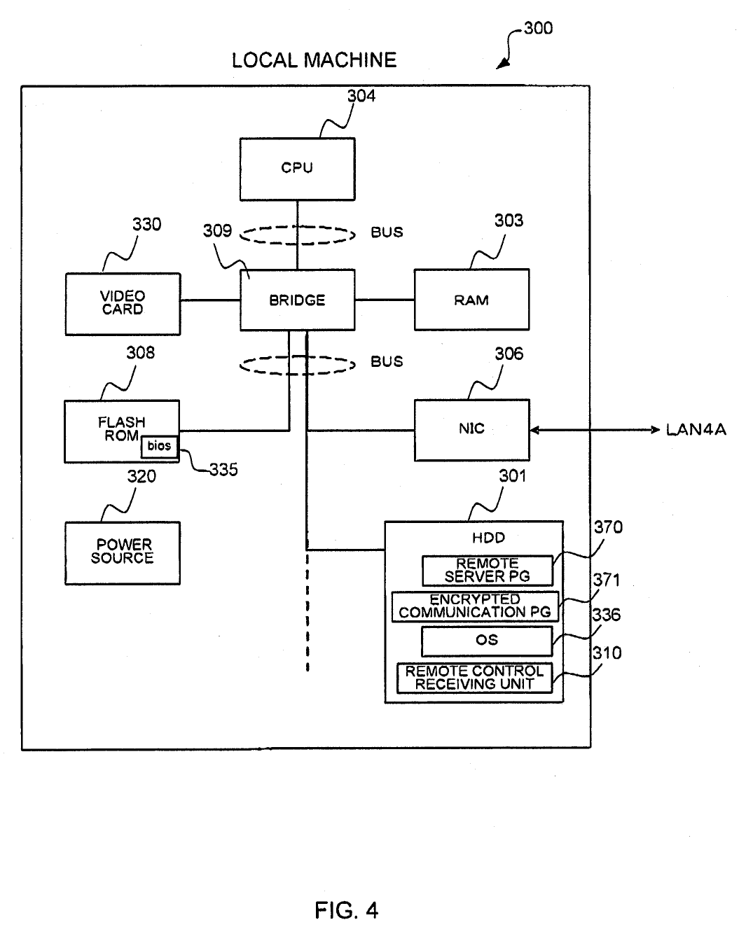

FIG. 4 is a diagram showing an exemplary structure of the local machine 300 in the present embodiment. The local machine 300 is an apparatus that is assigned by the management server 100 and is used by the remote machine 200 through a network. In order to implement functions for realizing the present embodiment, the local machine 300 reads out to a RAM 303 a program 302 contained in a program database stored in a HDD (hard disk drive) 301 or the like, and executes the program 302 by a processing unit, a CPU 304.

Further, the local machine 300 may include an input/output interface 305 which may be in the form of, for example, a keyboard, a button, a display, or other input/output means, as commonly equipped with a computer device. The local machine 300 also includes a NIC (Network Interface Card) 306 for exchanging data with the management server 100, the remote machine 200 and others.

The local machine 300 connects and exchanges data with the management server 100, the remote machine 200 and others by the NIC 306 through the network 140 which may be in the form of, for example, the Internet, a LAN, or a serial interface communication line. An I/O unit 307 is responsible for data buffering and various intermediary processing between the NIC 306 and the functional components of the local machine 300. The local machine 300 further includes a flash ROM (Read Only Memory) 308, a video card 330 which generates image information to be displayed on a desktop, a bridge 309 which bridges between buses connecting the above-mentioned components 301 to 330, and a power source 320.

A BIOS (Basic Input/Output System) 335 is stored in the flash memory 308.

When the power source 320 is turned on, the CPU 304 first accesses the flash ROM 308 and executes the BIOS 335, and thereby recognizes the system configuration of the local machine 300.

As the functional unit that the local machine 300 sets up and retains, for example, based on the program 302, there is prepared a remote control receiving unit 310 for receiving manipulation information from the remote machine 200, performing information processing according to manipulation indicated by the received manipulation information, and sending to the remote machine 200 image information showing the processing result.

Further, the local machine 300 stores in the HDD 301 a remote server program 370, an encrypted communication program 317, and an OS (Operating System) 336. The OS 336 is a program enabling the CPU 304 to perform overall control of the components 301 to 330 of the local machine 300 and execute programs for implementing functional units such as the above-mentioned functional unit 310. The CPU 304 loads the OS 336 from the HDD 301 to the RAM 303 by running the BIOS 335, and starts the OS 336, and thereby performs overall control of the components 301 to 330 of the local machine 300.

The remote server program 370 is a program allowing a user to remotely control the desktop of the local machine 300 through manipulating the remote machine 200, and may be embodied as, for example, the VNC (Virtual Network Computing) server program developed at AT & T Laboratories Cambridge. The CPU 304, under the support of the OS 336, loads the remote server program 370 from the HDD 301 to the RAM 303 and executes the program 370, and thereby receives and processes manipulation information (user manipulation of a keyboard or a mouse) sent from the remote machine 200 through the network 140 which may be a VPN, and then sends image information showing the process result (a desktop screen of a display) to the remote machine 200 through the network 140 which may be a VPN.

The encrypted communication program 371 is a program for establishing the network 140 which may be a VPN between the local machine 300 and the remote machine 200, and may be embodied as, for example, a communication program using IPsec (Security Architecture for the Internet Protocol). The CPU 304, under the support of the OS 336, loads the encrypted communication program 371 from the HDD 301 to the RAM 303 and executes the program 371, and thereby accepts a communication start request sent from the remote machine 200 through the NIC 306, and establishes the secured network 140 which may be a VPN with the remote machine 200, and performs communication with the machine 200 through the established network 140 which may be a VPN.

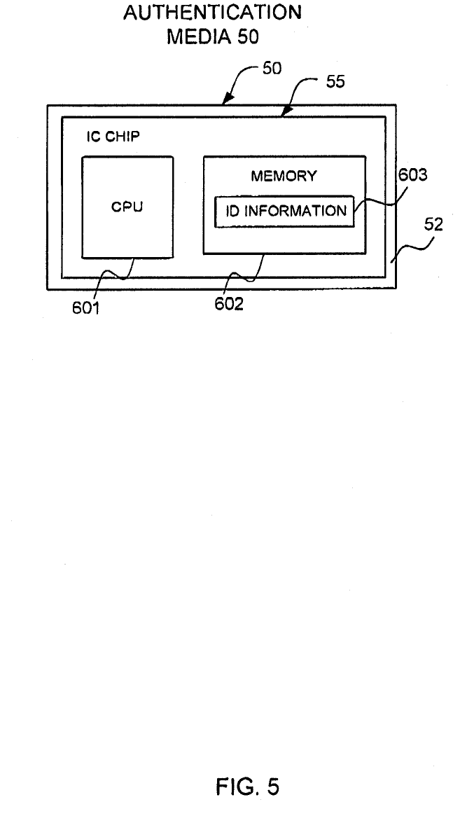

FIG. 5 is a diagram showing an exemplary structure of an IC chip 55 mounted in the authentication media 50 in the present embodiment. The authentication media 50 may be embodied as an IC card in which the wireless IC chip 55 is contained in suitable containing material 51 such as plastic, for example, a transportation IC card. The stored information in the wireless IC chip 55 includes an authentication IC-chip ID. The before-mentioned access key is generally required in reading the stored information in the wireless IC chip 55 through the reader 60 or the like. The wireless IC chip 55 comprises a CPU 601 and a memory 602 storing chip ID information 603. The wireless IC chip 55 is connected to an antenna 52 installed in the containing material 51 and performs wireless data communication with the reader 60.

It should be noted that the above-mentioned functional units 110 to 112, 210 to 218, 310 and the like in the management server 100, the remote machine 200, and the local machine 300 included in the remote desktop system 10 may be implemented as hardware, or as software stored in an appropriate storage device such as a memory or a HDD (Hard Disk Drive). In the latter case, in implementing the functional unit, the above-mentioned CPU 104, 204, or 304 reads out the corresponding program from a storage device to the RAM 103, 203, or 303, and executes it.

It should be also noted that, besides the Internet and a LAN, various types of network are also usable as the before-mentioned network 140, such as an ATM line, a private line, a WAN (Wide Area Network), a power line network, a wireless network, a public line network, a mobile phone network, a serial interface communication network and so on. Furthermore, preferably, the virtual private network technology or VPN may be used for the network 140 so that it is possible to establish more secured communication even in the case of using the Internet. Meanwhile, the above-mentioned serial interface refers to an interface for connecting to an external device in serial transmission where data is transmitted serially bit by bit with use of a single signal line, and a communication method used for it may be, for example, RS-232C, RS-422, IrDA, USB, IEEE1394, or Fiber Channel.

Database Structure

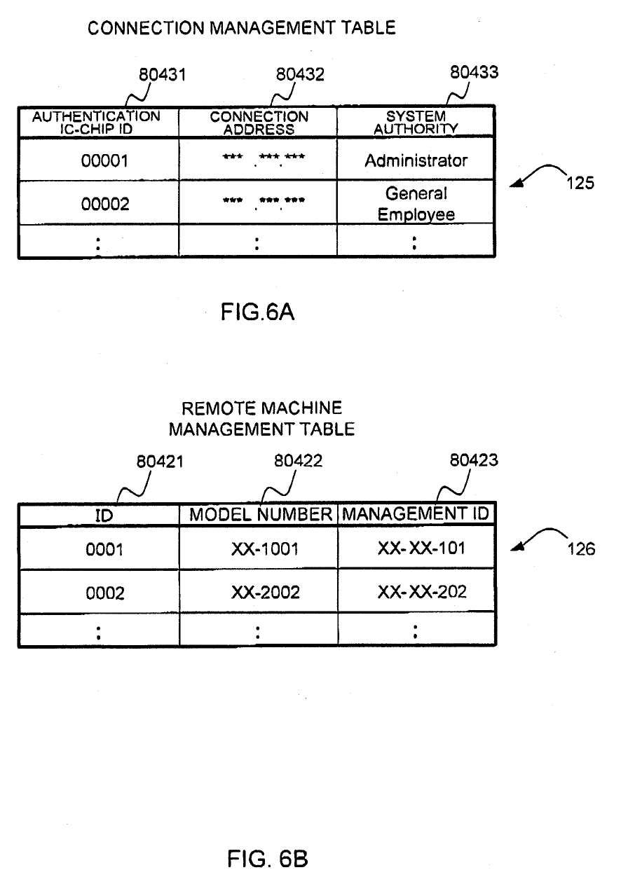

Next, a description is given as to the structures of tables stored in the management server 100 included in the remote desktop system 10 in the present embodiment. FIGS. 6A and GB are diagrams respectively showing exemplary data structures of a connection management table and a remote machine management table in the present embodiment.

The connection management table 125 is a table for containing the relationship between the stored information of the authentication media 50 used by a user of each of the plurality of remote machines 200, and the address of the local machine 300 that is assigned to be used by the remote machine 200 associated to the authentication media 50. For example, the table 125 may be a collection of records, each of which contains a chip ID 80431 as a key, which is an ID of the IC chip 55 mounted on the authentication media 50, a connection address 80432 which is an address of the local machine 300, and a system authority 80433 which indicates an authorized extent of being able to use the local machine 300 according to job position or the like, or similar information, relating each information with the other.

The remote machine management table 126 is a table for containing the authentication information of each of the plurality of remote machines 200 (for example, device information such as MAC address). For example, the table 126 may be a collection of records, each of which contains an ID 80421 of the remote machine 200 as a key, and a model number 80422 thereof, and a management ID 80423 set to the remote machine 200, relating each information with the others.

Example of First Process Flow

Hereinafter, actual process flows of an information processing method in the present embodiment will be described with reference to the drawings. Note that the steps described below in the information processing method are carried out with the programs read out to and executed in the respective RAMs of the management server 100, the remote machine 200, and the local machine 300 included in the remote desktop system 10, and these programs comprise codes for carrying out the steps described below.

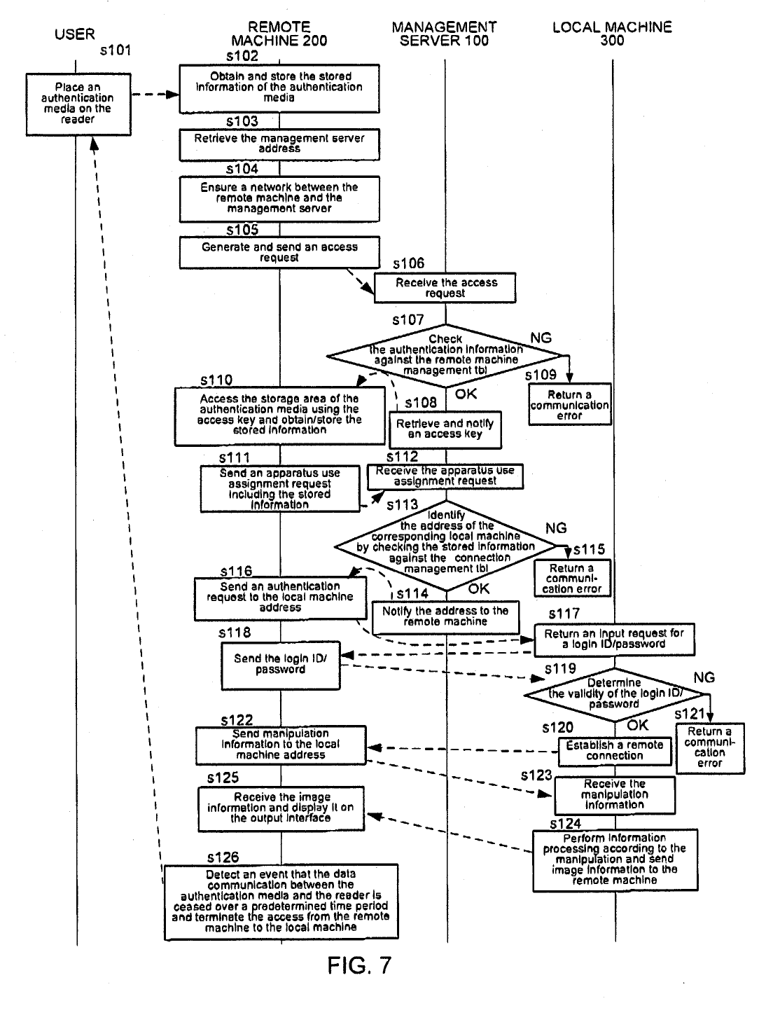

FIG. 7 is a diagram showing an example of a first process flow in the information processing method in the present embodiment. This represents a process flow in the case where the remote machine 200 is not equipped with the biometric authentication device 216, and therefore the biometric authentication initiation program 272 does not instruct the biometric authentication processing unit 217 to start a biometric authentication process.

Assume that a user having the authentication media 50 such as a transportation IC card is about to use the local machine 300 through the remote machine 200. In this case, a scan process is started by, for example, the user's placing the authentication media 50 over the reader 60 of the remote machine 200 (s101). In the remote machine 200, the authentication information obtaining unit 210 obtains the stored information of the authentication media 50 through the reader 60, and stores the obtained information in an appropriated RAM such as the RAM 203 (s102). The stored information is information used in authenticating the authentication media.

Then, in the remote machine 200, the encrypted communication program 271 is started, whereas the apparatus use assignment request sending unit 212 accesses the management server address storage unit 211 and retrieves the address of the management server (the address for internal network, since this is the case that biometric authentication is not performed and security level is relatively low) (s103). The apparatus use assignment request sending unit 212 notifies the retrieved address of the management server 100 to the encrypted communication program 271. The encrypted communication program 271 receives this address and ensures a network such as the LAN 4A between the remote machine 200 and the management server 100 (s104).

The remote machine 200 generates an access request including the authentication information of the remote machine 200 such as the device information 273 in the TPM 201, and sends this request to the management server 100 through the LAN 4A (s105).

The management server 100 receives from the remote machine 200 the access request including the authentication information of the remote machine 200 (s106), and checks this authentication information against the remote machine management table 126. Then, the management server 100 determines whether or not to accept the access requested from the remote machine 200 according to whether or not the authentication information is consistent with the contents of the table 126(s107).

If the determination result is “Access Accepted” (s107: OK), then the access key notification unit 112 of the management server 100 retrieves the access key from the access key storage unit 111 and notifies the retrieved access key to the remote machine 200 (s108). On the other hand, if the determination result is “Access Denied” (s107: NG), then a reply indicating a communication error is sent to the remote machine 200 (s109) and the process is ended.

Once the remote machine 200 receives the access key from the management server 100, the authentication information obtaining unit 210 accesses the storage area 602 of the authentication media 50 through the reader 60 for the authentication media 50 with use of the received access key, and then obtains the stored information in the storage area 602 (e.g. authentication IC-chip ID) and stores the obtained information in an appropriate RAM such as the RAM 203 (s110). This stored information may be in the form of, for example, an authentication IC-chip ID that is stored in the wireless IC chip 55 of the authentication media 50.

The apparatus use assignment request sending unit 212 of the remote machine 200 retrieves from the RAM 203 the stored information of the authentication media 50 (authentication IC-chip ID), and puts the retrieved stored information in an apparatus use assignment request for requesting an assignment of the local machine 300 to use, and sends this request to the address of the management server 100 stored in the management server address storage unit 211 (the address for internal network, since this is the case that biometric authentication is not performed and security level is relatively low)(s111).

Then, the address notification unit 110 of the management server 100 receives from the remote machine 200 the apparatus use assignment request including the stored information of the authentication media 50 (authentication IC-chip ID) (s112), and checks the received stored information (authentication IC-chip ID) against the connection management table 125, and identifies the connection address 80432 of the local machine 300 (s113: OK), and notifies the identified address to the remote machine 200, the sender of the apparatus use assignment request (s114). On the other hand, if the address of the local machine 300 cannot be identified (s113: NG) as a result of checking the stored information of the authentication media 50 against the connection management table 125, a reply indicating a communication error is sent to the remote machine 200 (s115), and the process is ended.

Subsequently, the remote client program 270 stored in the TPM 201 of the remote machine 200 sends an authentication request to the notified address of the local machine 300 (s116). Responding to this request, the local machine 300 sends to the remote machine 200 an input request prompting the user to input, for example, a login ID and a password for logging in to the local machine 300 (s117). After the remote machine 200 sends the login XD and the password in response to the input request (s118), the local machine 300 determines whether or not the login ID and the password sent from the remote machine 200 match the ones managed by the local machine 300 (s119), and thereby determines whether or not to accept the request for using the local machine 300.

If the determination result is “Login Accepted” (s119: OK), then the local machine 300 establishes a remote connection with the remote machine 200 (s120). On the other hand, if the determination result is “Login Denied” (s119: NG), then a reply indicating a communication error is sent to the remote machine 200 (s121), and the process is ended.

In this way, the management server 100 in the present embodiment plays a role of leading to establishment of a one-to-one remote connection between the remote machine 200 and the local machine 300 by serving for authentication and notification of a connection address in response to a request for an access from the remote machine 200 to the local machine 300. Unlike this way, for example, if the management server 100 is in charge of mediating a connection from the remote machine 200 to the local machine 300, and also relaying data exchange in a remote connection therebetween, there would be far more tasks that the server 100 has to undertake, such as holding a network band required in a remote connection for every remote connection and performing data communication processing for every remote connection, so that the process load put on the management server 100 would be much heavier. Therefore, as in the present embodiment, by making the management server 100 responsible for just fixing up initiation of a remote connection between the remote machine 200 and the local machine 300 through offering the machine 200 a connection address of the machine 300, it is possible to reduce the process load on the management server 100 to an appropriate amount, and thereby maintain excellent process efficiency.

Once the remote connection is established between the remote machine 200 and the local machine 300, data communication using this remote connection is started therebetween. At this time, the address obtaining unit 213 of the remote machine 200 has already stored the address of the local machine 300 assigned to the remote machine 200 in an appropriate RAM such as the RAM 203, after having received it from the management server 100.

The remote control unit 214 of the remote machine 200 sends manipulation information inputted through the input interface 205 of the remote machine 200 to the address of the local machine 300 stored in the RAM 203 (s122). Meanwhile, the remote control receiving unit 310 of the local machine 300 receives the manipulation information from the remote machine 200 (s123), and performs information processing according to manipulation indicated by the manipulation information, and sends image information showing the processing result to the remote machine 200 (s124). In the remote machine 200, the remote control unit 214 receives from the local machine 300 the image information corresponding to the manipulation information and displays it on the output interface 205 of the remote machine 200 (s125). In data processing related to remote desktop, the remote client program 270 and the remote control unit 214 may work together. Running the remote client program 270, the CPU 204 of the remote machine 200 sends to the local machine 300 input information inputted through the I/O connector 260 (user manipulation of a keyboard or a mouse) through the LAN 4A, and outputs image information (a desktop screen of a display) sent from the local machine 300 through the LAN 4A on the input/output interface 205 such as a display connected to the video card 230, or other output means.

After the remote connection is established between the remote machine 200 and the local machine 300, the disconnection timer/handler unit 218 of the remote machine 200 detects, through the reader 60 for the authentication media 50, an event that the data communication between the authentication media 50 and the reader 60 is ceased over a predetermined time period, and in response to such detection, performs a process of terminating the access from the remote machine 200 to the local machine 300 (s126). This procedure can prevent, for example, a possible incident such that, while an authorized user leaves the remote machine 200 for a little carrying his/her authentication media 50 with him/her, another person might manipulate the remote machine 200 to use the local machine 300.

On the contrary, this procedure might cause some inconvenient situations. For example, the authentication media 50 placed on the reader 60 might be accidentally moved to a position more than a predetermined distance off from the reader 60, and as a result, the remote connection between the remote machine 200 and the local machine 300 might be terminated by the above-mentioned step s126 regardless of an authorized user's intention. Or, in the case of adopting a mobile phone equipped with the wireless IC chip 55 as the authentication media 50, when a user receives a call with the mobile phone and the distance between the reader 60 and the wireless IC chip 55 in the phone exceeds a limit, the remote connection might be also terminated by the step s126.

In consideration of these possibilities, when the disconnection timer/handler unit 218 detects, through the reader 60 for the authentication media 50, an event that data communication between the authentication media 50 and the reader 60 is ceased over a predetermined time period, additional time counting may be started instead of immediate access termination. At the same time, an output indicating that “the authentication media 50 (or a mobile phone) is more than a predetermined distance off from the reader 60” may be displayed on the output interface 205 of the remote machine 200, calling user's attention to this off state. After that, it still the off state continues and a predetermined time has elapsed, a warning of “Access Termination Approaching” and information of “Time Remaining until Access Termination” may be displayed on the output interface 205. With such a warning, the user may be given a chance to know the off state and a grace to get the media 50 back on the reader 60. If further a predetermined time has elapsed, then the disconnection timer/handler unit 218 may eventually perform the process of terminating the access from the remote machine 200 to the local machine 300 as in the above-mentioned step s216.

According to this way, when the authentication media 50 is separated from the reader 60, the remote connection is not terminated immediately and a predetermined grace is given to a user, so that an accidental off state is allowed to a certain extent, avoiding access termination accompanied by an authorized user's inconvenience, thereby providing better usability.

Example of Second Process Flow

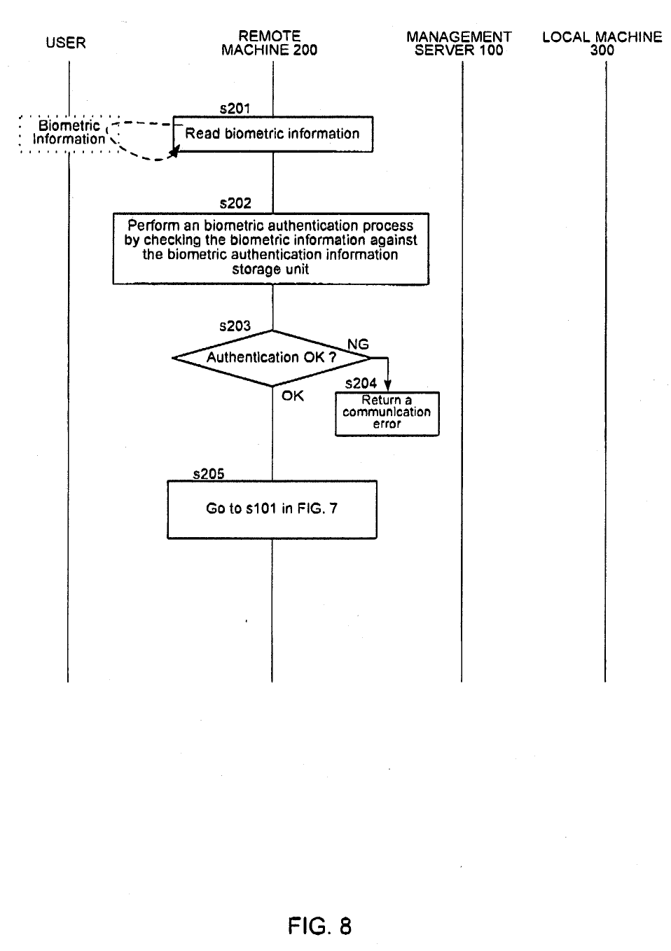

FIG. 8 is a diagram showing an example of a second process flow in the information processing method in the present embodiment.

This represents a flow process in the case where the remote machine 200 is equipped with the biometric authentication device 216, and therefore the biometric authentication initiation program 272 instructs the biometric authentication processing unit 217 to start a biometric authentication process. In this case, upon startup of the remote machine 200, the biometric authentication initiation program 272 recognizes the hardware configuration of the remote machine 200, and thereby recognizes that the biometric authentication device 216 is included in the hardware configuration.

Receiving the instruction to start a biometric authentication process, the biometric authentication processing unit 217 of the remote machine 200 starts to read user's biometric information through the biometric authentication device 216 (s201). Then, the biometric authentication processing unit 217 performs the biometric authentication process by checking the biometric information obtained through the biometric authentication device 216 against the information in the biometric authentication information storage unit 215 (s202). If the user is not authenticated in the biometric authentication (s203: NG), then a communication error is outputted and the process of assigning the local machine 300 to the remote machine 200 is ended (s204). On the other hand, if the user is authenticated in the biometric authentication (s203: OK), then the process flow advances to the step s101 in the above-mentioned first process flow (s205). For the subsequent steps, the description is omitted since they are the same as those in the first process flow. Though in the second process flow, biometric authentication is additionally performed, so that a remote connection through an external network is also supported. Therefore, as the management server address, the one for external network may be used. In this case, the remote machine 200 may connect through the LAN 4B, i.e., an external network at a train station, a hotel or the like, and the router 3B to the network 140, then establish a remote connection with the local machine 300.

In the above description on the embodiment, generally, there has been discussed the case where a VPN is established between the local machine 300 and the remote machine 200 in communication therebetween. However, the present invention is not limited to this case. For example, when the local machine 300 and the remote machine 200 exist in the same LAN, communication between the local machine 300 and the remote machine 200 may be performed without establishing a VPN.

Moreover, although the authentication media 50 may be preferably embodied as an IC card such as a transportation IC card equipped with the wireless IC chip 55, the media 50 may be also embodied as a mobile phone equipped with a similar IC chip. Or, the media 50 may be embodied as even an authentication media without an IC chip, as long as it has at least one unique ID electrically readable by any kind of reader, regardless of its information recording method and encryption method.

As described above, according to the present invention, it becomes possible to ensure appropriate security and usability in a thin client system with use of an authentication media having excellent portability.

Although a specific exemplary embodiment of the present invention has been shown by way of example in the drawings and has herein be described in detail, it should be understood that there is no intent to limit the invention to the particular form disclosed, but on the contrary, the intent is to cover all modifications, equivalents, and alternatives falling within the spirit and scope of the invention.

What is claimed is:

1. An information processing system comprising a plurality of information processing apparatuses, a management server for managing the information processing apparatuses, and a plurality of terminals, which are connected with each other through a network, wherein;
the management server includes
a connection management table for storing a relationship between stored information of an authentication media used by a user of each of the plurality of terminals and an address of the information processing apparatus that is assigned to be used by the terminal associated to the authentication media, and
an address notification unit for receiving from the terminal an apparatus use assignment request including the stored information of the authentication media, checking the stored information of the authentication media that is included in the received request against the connection management table, identifying the address of the corresponding information processing apparatus, and notifying the identified address to the terminal that is the sender of the apparatus use assignment request;
the terminal includes
an authentication information obtaining unit for obtaining the stored information of the authentication media through a reader for the authentication media, and storing the obtained information in an appropriate memory,
a management server address storage unit for storing an address of the management server,
an apparatus use assignment request sending unit for retrieving the stored information of the authentication media from the memory, putting the retrieved stored information in the apparatus use assignment request, and sending this apparatus use assignment request to the management server address stored in the management server address storage unit,
an address obtaining unit for receiving from the management server the address of the information processing apparatus assigned to the terminal, and storing the received address in an appropriate memory, and
a remote control unit for sending manipulation information inputted through an input interface of the terminal to the information processing apparatus address stored in the memory, and receiving from the information processing apparatus image information corresponding to the sent manipulation information, and displaying the received image information on an output interface of the terminal; and
the information processing apparatus includes a remote control receiving unit for receiving the manipulation information from the terminal, performing information processing according to manipulation indicated by the received manipulation information, and sending the image information showing the processing result to the terminal.

2. An information processing system according to claim 1, wherein:
the management server includes
a remote machine management table for storing authentication information of each of the plurality of terminals,
an access key storage unit for storing an access key to a storage area of the authentication media, and
an access key notification unit for receiving from the terminal an access request including the authentication information of the terminal, determining whether or not to accept an access requested from the terminal by checking the authentication information included in the received access request against the remote machine management table, and if the requested access is determined acceptable, then retrieving the access key from the access key storage unit, and notifying the retrieved access key to the terminal that is the sender of the access request; and
the authentication information obtaining unit in the terminal receives the access key from the management server, accesses the storage area of the authentication media through the reader for the authentication media with use of the received access key, obtains the stored information in the storage area, and stores the obtained information in an appropriate memory.

3. An information processing system according to claim 1, wherein:
the terminal includes
a biometric authentication information storage unit for storing biometric authentication information of a terminal user,
a biometric authentication device for obtaining biometric information of a terminal user, and
a biometric authentication processing unit for performing a biometric authentication process by checking the biometric information obtained through the biometric authentication device against the information in the biometric authentication information storage unit, and if the user is not authenticated in the biometric authentication, then terminating an apparatus use assignment process for assigning the information processing apparatus to the terminal.

4. An information processing system according to claim 1, wherein the terminal includes a disconnection timer/handler unit for detecting, through the reader for the authentication media, an event that data communication between the authentication media and the reader is ceased over a predetermined time period, and terminating an access from the terminal to the information processing apparatus according to the detected event.

5. An information processing system according to claim 1, wherein the authentication media is a media equipped with a wireless IC chip, and the stored information thereof includes a chip ID.

6. A management server which intermediates between a plurality of information processing apparatuses and a plurality of terminals using the information processing apparatuses which are connected with each other through a network, and manages an assignment of the information processing apparatus to the terminal, comprising:
a connection management table for storing a relationship between stored information of an authentication media used by a user of each of the plurality of terminals and an address of the information processing apparatus that is assigned to be used by the terminal associated to the authentication media; and
an address notification unit for receiving from the terminal an apparatus use assignment request including the stored information of the authentication media, checking the stored information of the authentication media that is included in the received request against the connection management table, identifying the address of the corresponding information processing apparatus, and notifying the identified address to the terminal that is the sender of the apparatus use assignment request.

7. A management server according to claim 6, further comprising:
an access key storage unit for storing an access key which allows the terminal to access a storage area of the authentication media; and
an access key notification unit for, in receiving from the terminal an access request for requiring a communication connection, retrieving the access key from the access key storage unit, and notifying the retrieved access key to the terminal that is the sender of the access request.

8. A terminal which uses, through a network, an information processing apparatus assigned by a management server, comprising:
an authentication information obtaining unit for obtaining, through a reader for an authentication media used by a user of each of the terminals, stored information of the authentication media, and storing the obtained information in an appropriate memory;
a management server address storage unit for storing an address of the management server;
an apparatus use assignment request sending unit for retrieving the stored information of the authentication media from the memory, putting the retrieved stored information in an apparatus use assignment request, and sending this apparatus use assignment request to the management server address stored in the management server address storage unit;
an address obtaining unit for receiving from the management server the address of the information processing apparatus assigned to the terminal, and storing the received address in an appropriate memory; and
a remote control unit for sending manipulation information inputted through an input interface of the terminal to the information processing apparatus address stored in the memory, and receiving from the information processing apparatus image information corresponding to the sent manipulation information, and displaying the received image information on an output interface of the terminal.

9. A method for managing a connection to an information processing apparatus executed in a system comprising a plurality of the said information processing apparatuses, a management server for managing the information processing apparatuses, and a plurality of terminals, which are connected with each other through a network, the method comprising:
the terminal sending an apparatus use assignment request to the management server;
the management server identifying the information processing apparatus corresponding to the terminal based on the received request, and
sending an address of the identified information processing apparatus to the terminal; and
the terminal performing the communication connection to the information processing apparatus based on the received address.

10. A method for managing a connection to an information processing apparatus according to claim 9, wherein the management server includes a remote machine management table for storing authentication information of each of the plurality of terminals, and an access key storage unit for storing an access key to a storage area of an authentication media used by a user of each of the terminals, the method comprising:
the management server receiving from the terminal an access request including the authentication information of the terminal,
determining whether or not to accept an access requested from the terminal by checking the authentication information included in the received access request against the remote machine management table, and
if the requested access is determined acceptable, then retrieving the access key from the access key storage unit and notifying the retrieved access key to the terminal that is the sender of the access request; and
the terminal receiving the access key from the management server,
accessing the storage area of the authentication media through a reader for the authentication media with use of the received access key, and
obtaining the stored information in the storage area and storing the obtained information in an appropriate memory.

11. A method for managing a connection to an information processing apparatus according to claim 9, wherein the terminal includes a biometric authentication information storage unit for storing biometric authentication information of a terminal user, the method comprising:
the terminal obtaining biometric information of a terminal user,
performing a biometric authentication process by checking the biometric information obtained through a biometric authentication device against the information in the biometric authentication information storage unit, and
if the user is not authenticated in the biometric authentication, then terminating an apparatus use assignment process for assigning the information processing apparatus to the terminal.

12. A method for managing a connection to an information processing apparatus according to claim 9, the method comprising:
the terminal detecting, through a reader for an authentication media, an event that data communication between the authentication media and the reader is ceased over a predetermined time period, and
terminating an access from the terminal to the information processing apparatus according to the detected event.

13. A method for managing a connection to an information processing apparatus according to claim 9, wherein an authentication media used by a user of each of the plurality of terminals is a media equipped with a wireless IC chip, and stored information of the authentication media includes a chip ID.
